(19) United States
(12) Patent Application Publication
(10) Pub. No.: US 2014/0370409 A1
(43) Pub. Date: Dec. 18, 2014

(54) COOLING PUMP DRIVING SYSTEM

(71) Applicant: Hyundai Motor Company, Seoul (KR)

(72) Inventors: Jeong Kyu PARK, Yongin-si (KR); Dong Hoon KIM, Seoul (KR); Young Pin JIN, Yongin-si (KR)

(73) Assignee: HYUNDAI MOTOR COMPANY, Seoul (KR)

(21) Appl. No.: 14/020,540

(22) Filed: Sep. 6, 2013

(30) Foreign Application Priority Data
Jun. 13, 2013 (KR) 10-2013-0067864

(51) Int. Cl. H01M 8/04; F04D 15/00

(52) U.S. Cl. CPC H01M 8/04029; F04D 15/0066
USPC 429/437; 415/26; 417/44.2

(57) ABSTRACT

A cooling pump driving system includes an electric water pump in a coolant passage line for circulating a coolant and having a variable rotation speed. A sensor disposed at an outlet side of the electric water pump checks a coolant pressure passing through the electric water pump. A controller including a reference value for the pressure change is configured to decrease a rotation speed of the electric water pump when the pressure change detected by the sensor is the reference value or higher.

### CROSS REFERENCE TO RELATED APPLICATION

This application claims under 35 U.S.C. §119(a) the benefit of Korean Patent Application No. 10-2013-0067864 filed on Jun. 13, 2013, the entire contents of which are incorporated herein by reference.

### TECHNICAL FIELD

The present disclosure relates to a cooling pump driving system capable of minimizing damage to a pump by introducing a sufficient amount of coolant into a pump inlet end at the time of starting a fuel cell vehicle engine and discharging the coolant to an outlet end to stabilize driving.

### BACKGROUND

In general, vehicles burn fuel in order to operate, thereby generating heat. In a fuel cell vehicle, the heat generated by a chemical reaction between hydrogen and water may damage vehicle components. The vehicle may not operate properly due to the damage caused by the heat, such that, a cooling system is necessary in the vehicle.

As the cooling system, a water cooling type cooling system and/or an air cooling type cooling system may be used. The water cooling type cooling system having high cooling efficiency is widely used. The water cooling type cooling system includes a radiator, a water pump, and a blower, and circulates a coolant in a coolant passage through the water pump. The coolant cooled by the radiator is circulated, thereby cooling heated components of the vehicle.

Due to environmental problems such as an increase of carbon dioxide, global warming, and the like, an interest in an environment-friendly vehicle has increased, such that various environment-friendly vehicles, such as a hybrid vehicle, an electric motor vehicle, a plug-in vehicle, a fuel cell vehicle, and the like, that use electricity as a driving source, have been developed and produced.

These vehicles use electricity as the driving source to drive a motor using a battery. Efficiency of the battery increases by controlling a battery temperature.

In the fuel cell vehicle, a fuel cell stack is used. In order to stably drive the fuel cell vehicle, a predetermined temperature of the fuel cell stack needs to be maintained. A cooling system maintaining a temperature of the fuel cell stack at a predetermined temperature by circulating a coolant has been used in the fuel cell vehicle.

Referring to FIG. 1, in the case of a large vehicle using a fuel cell according to the related art, a fuel cell stack 12 is disposed at the rear of the vehicle, a radiator 14 connected to the fuel cell stack 12 through a coolant passage is disposed at a roof of the rear of the vehicle. The fuel cell also includes a water pump 16 for circulating a coolant of the radiator 14 to the fuel cell stack 12. The fuel cell stack 12 exchanges heat with the coolant through a heat exchange structure. The fuel cell stack 12 is disposed at a lower portion of the vehicle, and the radiator 14 is disposed at an upper portion of the vehicle. A length from the radiator 14 to an inlet end of the water pump 16 is relatively long, and the coolant passages at the inlet end and an outlet end of the water pump have the same length, thus generating a large resistance to the circulation of coolant.

Therefore, there is insufficient coolant introduced into the inlet end of the water pump 16 when starting the water pump 16, such that unstable rotation of the water pump 16 damages internal components and ultimately damages the water pump 16.

Referring to FIG. 1, a cooling line 10 for cooling the fuel cell 12 and a cooling line 20 for conditioning air of the vehicle and cooling an electric component 22 are connected to each other. In the case of the fuel cell stack 12 used in a large bus, the fuel cell has a relatively great ability to generate high heat, therefore requires a large coolant capacity is required.

That is, the cooling line for cooling the fuel cell is different according to a coolant capacity and heat generation from the cooling line for conditioning the air of the vehicle and cooling the electric component, such that a pressure difference between the cooling lines occurs. As a result, because the coolant travels between the cooling lines, the coolant may be insufficient in any one of the cooling lines.

### SUMMARY

An aspect of the present disclosure provides a cooling pump driving system capable of preventing damage to internal components from a load generated in a water pump and improving a cooling line of a fuel cell vehicle by introducing a sufficient amount of coolant into the water pump at the time of starting the water pump.

According to an exemplary embodiment of the present disclosure, a cooling pump driving system includes an electric water pump disposed in a coolant passage line for circulating a coolant and having a variable rotation speed. A sensor disposed at an outlet side of the electric water pump checks a coolant pressure passing through the electric water pump. A controller including a reference value for a pressure change is configured to decrease a rotation speed of the electric water pump when the pressure change detected by the sensor is the reference value or higher.

The electric water pump may comprise a three-phase alternating current (AC) motor, and the controller may control a pump frequency, such that the rotation speed of the electric water pump varies.

The sensor may be a pressure sensor and detect an oscillation waveform of the pressure change of the coolant passing through the electric water pump.

A coolant passage of a front end of the electric water pump may protrude outward to define an internal space, such that a diameter of the coolant passage of a front side of the electric water pump is larger than that of the coolant passage of a rear side of electric water pump.

A coolant passage of a front end of the electric water pump may have an internal space capable of receiving the coolant therein and a buffer tank where the internal space and the coolant passage communicate with each other.

According to another exemplary embodiment of the present disclosure, a cooling pump driving system for a large bus includes a fuel cell cooling line including a fuel cell stack, an electric water pump pumping a coolant of a fuel cell radiator to circulate the coolant to the fuel cell stack. A sensor disposed at a rear end of the electric water pump checks a coolant pressure passing through the electric water pump. A vehicle cooling line including an electric water pump pumping a coolant of a vehicle radiator circulates the coolant to an electric component and the sensor disposed at a rear end of the electric water pump checks the coolant pressure passing through the electric water pump. A controller is configured to decrease a driving amount of the electric water pump of the fuel cell cooling line or the vehicle cooling line when the pressure change of the fuel cell cooling line or the vehicle cooling line is a reference value or higher.

The fuel cell cooling line and the vehicle cooling line may be separated from each other, such that the coolant does not move therebetween.

The fuel cell cooling line may protrude outward from a coolant passage of a front side of the electric water pump to define a space, such that a diameter of the coolant passage of the front side of the electric water pump is larger than that of a coolant passage of a rear side of electric water pump.

A coolant passage of a front end of the electric water pump of the fuel cell cooling line may have an internal space capable of receiving the coolant therein and a buffer tank where the internal space and the coolant passage communicate with each other.

### BRIEF DESCRIPTION OF THE DRAWINGS

FIG. 1 is a view showing a cooling system of a fuel cell vehicle according to the related art.

FIG. 2 is a configuration diagram of a cooling pump driving system according to an exemplary embodiment of the present disclosure.

FIG. 3 is a flow chart showing a pump control of the cooling pump driving system shown in FIG. 2.

FIG. 4 is a view showing an oscillation generated in the cooling pump driving system according to the related art.

FIG. 5 is a view showing an oscillation generated in the cooling pump driving system according to an exemplary embodiment of the present disclosure.

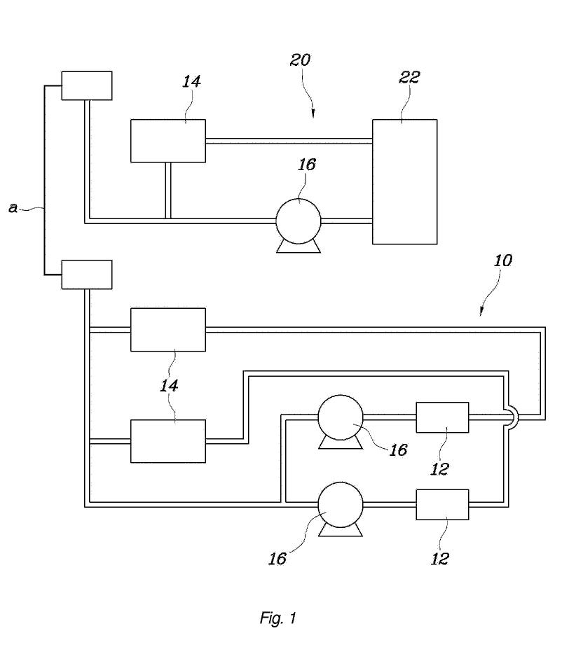

### DETAILED DESCRIPTION

Hereinafter, a cooling pump driving system according to exemplary embodiments of the present disclosure will be described with reference to the accompanying drawings.

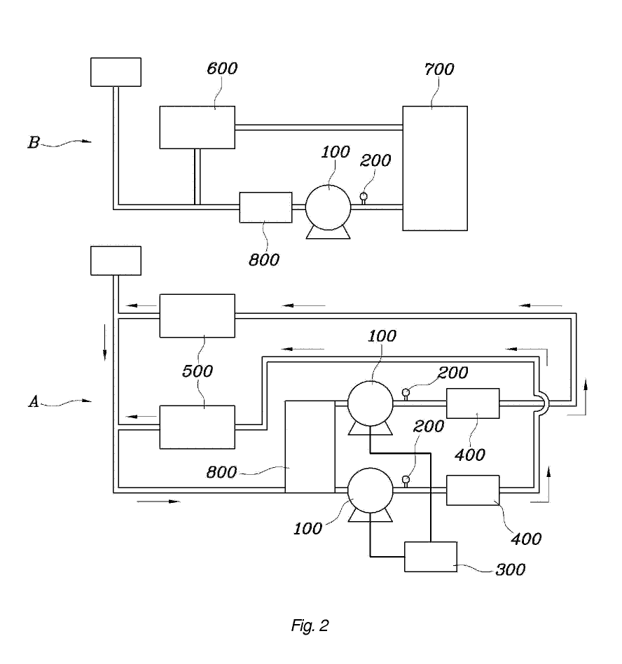

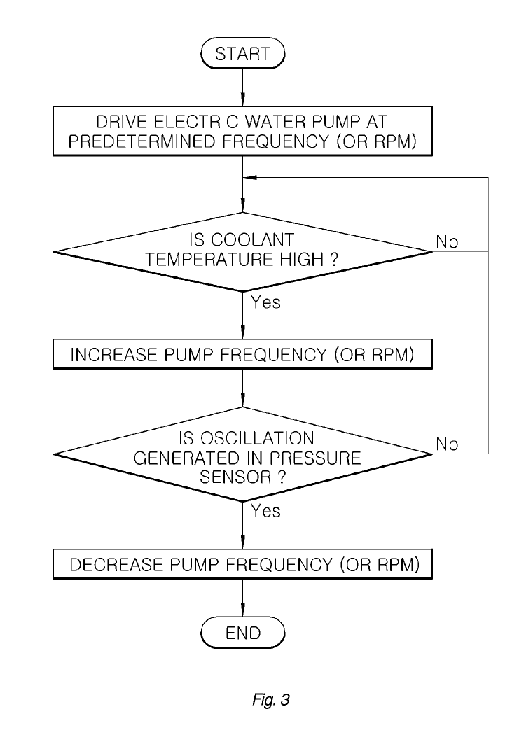

FIG. 2 is a configuration diagram of a cooling pump driving system according to an exemplary embodiment of the present disclosure; and FIG. 3 is a flow chart showing a pump control of the cooling pump driving system shown in FIG. 2. Here, exemplary embodiments of the present disclosure will be described with reference to the configuration diagram of the cooling pump driving system shown in FIG. 2.

In the cooling pump driving system according to an exemplary embodiment of the present disclosure, an air conditioning apparatus applied to a fuel cell vehicle will be described. A cooling pump driving system according to an exemplary embodiment of the present disclosure includes an electric water pump 100 in a coolant passage line for circulating a coolant and having a variable rotation speed. A sensor 200 disposed at a coolant outlet side of the electric water pump 100 checks a coolant pressure passing through the electric water pump 100. A controller 300 including a reference value for a pressure change is configured to decrease a driving amount of the electric water pump 100 when the pressure change detected by the sensor 200 is the reference value or higher.

The electric water pump 100 may comprise a three-phase alternating current (AC) motor, and the controller 300 controls a pump frequency, such that a rotation speed of the electric water pump 100 may varies.

The sensor 200 may be a pressure sensor and detect an oscillation waveform of the pressure change of the coolant passing through the electric water pump 100.

As shown in FIG. 2, the cooling pump driving system according to an exemplary embodiment of the present disclosure includes the electric water pump 100, the sensor 200, and the controller 300 in an air conditioning system of a vehicle.

In the electric water pump 100 according to an exemplary embodiment of the present disclosure, a driving motor is operated simultaneously with a start of the vehicle to circulate the coolant in a coolant passage. The driving motor may be the three-phase AC motor to variably control the rotation speed thereof. The controller 300 may control the pump frequency to control a motor speed in revolutions per minute (RPM) of the electric water pump 100.

Since the driving motor of the electric water pump 100 may be the three-phase AC motor, an inverter may be installed. When the controller 300 generates a control signal when a current is supplied, the inverter converts the frequency for the current value and then transfers the current value having the converted frequency to the driving motor of the electric water pump 100, thereby controlling the rotation speed of the electric water pump 100.

The operation of the electric water pump 100 as described above will be described in detail in the following description of the sensor 200.

In the cooling system according to an exemplary embodiment of the present disclosure, which secures durability of the electric water pump 100, the sensor 200 may be disposed at the coolant outlet side of the electric water pump 100 in order to recognize a state of the electric water pump 100. The sensor 200 may be a pressure sensor capable of checking a coolant pressure passing through the electric water pump 100 and detecting a pressure change of the coolant passing through the electric water pump 100 as an oscillation waveform.

As described above, the sensor 200 may detect the oscillation waveform caused by the pressure change of the coolant, and the controller 300 may decrease the driving amount of the electric water pump 100 in the case in which the oscillation caused by the pressure change generated is a reference amount or higher. Here, the driving amount of the electric water pump 100 may be controlled by the rotation speed of the electric water pump 100 by controlling the pump frequency as described above.

Therefore, at the time of starting a vehicle, the electric water pump 100 draws the coolant at an inlet side thereof. However, in the case in which there is not a sufficient amount of coolant in the coolant passage of an inlet end of the electric water pump 100, the pressure change of the coolant discharged to the outlet end of the electric water pump 100 is inconsistent, thus generating the oscillation.

The oscillation waveform is detected by the sensor 200 disposed at the outlet end of the electric water pump 100, and the controller 300 determines whether the oscillation is generated because the pressure change of the coolant is the reference value or higher.

When the oscillation is generated because the pressure change of the coolant is the reference value or higher, the pump frequency of the electric water pump 100 is decreased to decrease the rotation speed of the electric water pump 100. Therefore, the coolant is stably introduced into the inlet end of the electric water pump 100, and the oscillation generated at the outlet end of the electric water pump 100 is decreased.

The oscillation caused by the coolant discharge is detected by the sensor 200, thereby recognizing a load applied to the electric water pump 100. At the time of the generation of the oscillation, the pump frequency is decreased to decrease the driving amount of the electric water pump 100, thus preventing unstable driving of the electric water pump 100 and damage to internal components of the electric water pump 100.

FIG. 3 shows an operation flow of the cooling pump driving system according to an exemplary embodiment of the present disclosure described above. The pump frequency is immediately decreased when the oscillation is generated due to the coolant pressure by the sensor 200 in a state in which the electric water pump 100 is driven when starting the vehicle to decrease the driving amount of the electric water pump 100, thereby stably driving the electric water pump 100 and securing durability of the electric water pump 100.

A coolant passage of a front end of the electric water pump 100 according to an exemplary embodiment of the present disclosure protrudes outward from the coolant passage to define an internal space, such that a diameter of the coolant passage of a front side of the electric water pump 100 may be larger than that of the coolant passage of a rear side of electric water pump 100.

Here, a general coolant passage is filled with a coolant. Therefore, the coolant always fills the internal space.

The coolant passages of the inlet end and the outlet end of the electric water pump 100 have different sizes, and the diameter of the coolant passage of the front side of the electric water pump 100 is larger than that of the coolant passage of the rear side of electric water pump 100, thereby sufficiently introducing the coolant into the inlet end by driving the electric water pump 100 when starting the vehicle.

The increased diameter of the coolant passage of the front side of the electric water pump 100 secures a space to receive the coolant, thus sufficiently securing the coolant introduced into the inlet end when the electric water pump 100 is operated when starting the vehicle and preventing an insufficiency phenomenon of the coolant when driving the electric water pump 100.

As described above, a sufficient amount of coolant is supplied to the electric water pump 100, thus stably driving the electric water pump 100 and preventing damage to the internal components of the electric water pump 100.

The coolant passage of the front end of the electric water pump 100 may have the internal space capable of receiving the coolant therein and a buffer tank 800 where the internal space and the coolant passage communicate with each other.

According to another exemplary embodiment of the present disclosure, the coolant is sufficiently supplied into the electric water pump 100 at the time of driving the electric water pump 100. The electric water pump 100 is driven when starting the vehicle to simultaneously pump the coolant from the coolant passage of the front end and the buffer tank 800, thereby sufficiently introducing the coolant into the electric water pump 100.

As described above, the coolant introduced into the electric water pump 100 is secured to prevent an unstable operation caused by the insufficient amount of the coolant when driving the electric water pump 100, thereby securing durability of the electric water pump 100.

The cooling pump driving system according to another exemplary embodiment of the present disclosure includes a fuel cell cooling line A including a fuel cell stack 400, the electric water pump 100 pumping a coolant of a fuel cell radiator 500 to circulate the coolant to the fuel cell stack 400. A sensor 200 disposed at a rear end of the electric water pump 100 checks a coolant pressure passing through the electric water pump 100. A vehicle cooling line B including the electric water pump 100 pumping a coolant of a vehicle radiator 600 circulates the coolant to an electric component 700, and the sensor 200 disposed at a rear end of the electric water pump 100 checks the coolant pressure passing through the electric water pump 100. A controller 300 decreases a driving amount of the electric water pump 100 of the fuel cell cooling line A or the vehicle cooling line B in the case in which a pressure change of the fuel cell cooling line A or the vehicle cooling line B is the reference value or higher.

The cooling pump driving system according to another exemplary embodiment of the present disclosure, which may be applied to a large bus using a fuel cell, may be applied to a vehicle in which the fuel cell cooling line A for cooling the fuel cell and the vehicle cooling line B for conditioning air of the vehicle and cooling various electric components 700 are separated from each other.

In a large vehicle using a fuel cell according to the related art, since the amount of heat generated is increased in accordance with an increase in fuel cell capacity, a separate radiator apparatus is needed to cool the fuel cell.

Further, in a large bus, the radiator 500 for cooling the fuel cell is disposed at a rear roof of the vehicle, and the fuel cell stack 400 is disposed at a lower side of the rear of the vehicle. A coolant passage length from the radiator 500 to the electric water pump 100 is relatively long to generate a large flow resistance, such that the coolant is not sufficiently introduced into the electric water pump 100 when starting the electric water pump 100.

In order to solve this problem, in the coolant line for a fuel cell according to an exemplary embodiment of the present disclosure, the sensor 200 is disposed at the coolant outlet side of the electric water pump 100. The oscillation when the coolant is discharged from the electric water pump 100 to the outlet is detected, thereby making it possible to detect a load applied to the electric water pump 100.

Here, in the case in which the oscillation generated when the pressure change of the coolant is a reference value or higher, an electrical signal, that is, a pump frequency, transferred to the electric water pump 100 is decreased to decrease a driving amount of the electric water pump 100. Therefore, unstable driving of the electric water pump 100 and damage to the internal components of the electric water pump 100 are prevented.

Since the above-mentioned problem is generated in the large bus using the fuel cell, the fuel cell cooling line has been decreased. This may also be similarly applied to the vehicle cooling line as well as the fuel cell cooling line.

Meanwhile, the fuel cell cooling line A and the vehicle cooling line B are separated from each other, such that the coolant may not move therebetween.

In the large vehicle using the fuel cell, as the capacity of the fuel cell is increased, the coolant amount circulated in the vehicle cooling line B and the fuel cell cooling line A are different, and heat generated in the fuel cell and heat generated in the various electric components 700 are different, such that the amount of the coolant volume changes are different from each other. Therefore, the fuel cell cooling line A and the vehicle cooling line B are separated from each other, thus preventing the coolant from traveling in one cooling line to another due to a pressure difference and a volume difference and thereby preventing an error due to the coolant being mixed in the respective cooling systems.

The fuel cell cooling line A protrudes outward from the coolant passage of the front side of the electric water pump 100 to define a space, such that a diameter of the coolant passage of the front side of the electric water pump 100 may be larger than that of the coolant passage of the rear side of electric water pump 100.

The coolant passage of the front end of the electric water pump 100 of the fuel cell cooling line may have the internal space capable of receiving the coolant therein and the buffer tank 800 where the internal space and the coolant passage communicate with each other.

As described above, the increased diameter of the coolant passage of the front side of the electric water pump 100 and the buffer tank 800 sufficiently secure the coolant introduced into the inlet end when driving the electric water pump 100 and starting the vehicle.

The diameter of the coolant passage of the front side of the electric water pump 100 is increased or the buffer tank 800 secures a space to receive the coolant at the front side of the electric water pump 100, thus sufficiently securing the coolant introduced into the electric water pump 100 as the electric water pump 100 is operated when the vehicle starts.

The amount of coolant introduced into the electric water pump 100 is sufficient to stably drive the electric water pump 100, thereby preventing damage to the internal components of the electric water pump 100.

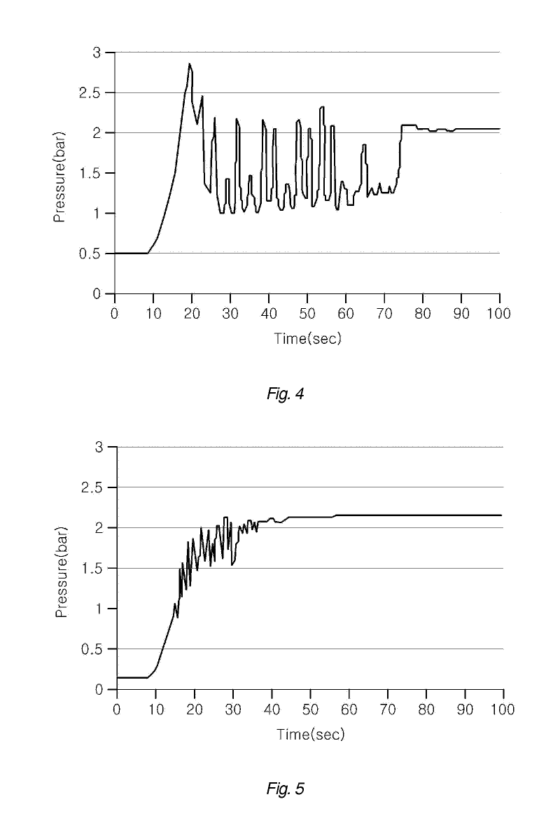

FIGS. 4 and 5 show oscillations generated in the cooling pump driving system according to the related art and the cooling pump driving system according to an exemplary embodiment of the present disclosure, respectively.

As shown in FIG. 4, in the cooling pump driving system according to the related art, when the electric water pump 100 is driven when starting a vehicle, the coolant is introduced into the electric water pump 100 and then discharged. The oscillation caused by the coolant pressure is continuous for about one minute.

That is, although a sufficient amount of the coolant is temporarily supplied into the electric water pump 100 at the time of an initial operation of the electric water pump 100 to increase the pressure, a resistance in the coolant passage prevents the coolant from being sufficiently introduced into the electric water pump 100. Therefore, the coolant supplied into the electric water pump 100 is insufficient to rapidly decrease the pressure, and the pressure of the coolant discharged to the outlet side of the electric water pump 100 becomes unstable. As a result, the driving motor in the electric water pump 100 rotates unstably.

Referring to FIG. 5, as the cooling pump driving system according to an exemplary embodiment of the present disclosure starts, when the electric water pump 100 is driven to introduce the coolant into the electric water pump 100, with the increased diameter of the coolant passage of the front side of the electric water pump 100 or the buffer tank 800 in line, the coolant introduced into the electric water pump 100 is sufficiently secured, thereby the electric water pump 100 can be stably driven.

As a result, the oscillation caused by the pressure of the coolant discharged to the outlet side of the electric water pump 100 becomes stable faster.

Further, in the case in which the oscillation detected by the sensor 200 is not stable, the pump frequency of the electric water pump 100 is controlled to decrease the driving amount of the electric water pump 100, thereby stably introducing the coolant into the inlet end of the electric water pump 100. When to sufficient amount of coolant is stably introduced into the electric water pump 100, the pressure of the coolant discharged is stabilized, decreasing the oscillation.

The cooling pump driving system according to an embodiment of the present disclosure monitors the coolant discharged through the electric water pump 100, thereby making it possible to recognize a state in which the electric water pump 100 is driven.

In the case in which the pressure change of the coolant is excessive due to the insufficient amount of coolant introduced into the electric water pump 100, the unstable driving of the electric water pump 100 decreases the driving amount of the electric water pump 100, thereby stably driving the electric water pump 100.

The electric water pump 100, controlled as described above, prevents damage to the internal components of the electric water pump 100 due to the load generated in the electric water pump 100.

Particularly, the improved pump control and the improved coolant passage according to an exemplary embodiment of the present disclosure are applied to large vehicles using fuel cells, thereby maintaining a cooling function of the fuel cell vehicle in an optimal state.

Although the present disclosure has been shown and described with respect to specific exemplary embodiments, it will be obvious to those skilled in the art that the present disclosure may be variously modified and altered without departing from the spirit and scope of the present disclosure as defined by the following claims.

What is claimed is:

1. A cooling pump driving system comprising:
an electric water pump in a coolant passage line for circulating a coolant and having a variable rotation speed;
a sensor disposed at an outlet side of the electric water pump to check a coolant pressure passing through the electric water pump; and
a controller including a reference value for a pressure change configured to decrease a rotation speed of the electric water pump when the pressure change detected by the sensor is the reference value or higher.

2. The cooling pump driving system of claim 1, wherein the electric water pump comprises a three-phase alternating current (AC) motor, and the controller controls a pump frequency, such that the rotation speed of the electric water pump varies.

3. The cooling pump driving system of claim 1, wherein the sensor is a pressure sensor and detects an oscillation waveform of the pressure change of the coolant passing through the electric water pump.

4. The cooling pump driving system of claim 1, wherein a coolant passage of a front end of the electric water pump protrudes outward to define an internal space, such that a diameter of the coolant passage of a front side of the electric water pump is larger than that of the coolant passage of a rear side of electric water pump.

5. The cooling pump driving system of claim 1, wherein a coolant passage of a front end of the electric water pump has an internal space capable of receiving the coolant therein and a buffer tank where the internal space and the coolant passage to communicate with each other.

6. A cooling pump driving system for a large bus, comprising:
a fuel cell cooling line including a fuel cell stack, an electric water pump pumping a coolant of a fuel cell radiator to circulate the coolant to the fuel cell stack, and a sensor disposed at a rear end of the electric water pump to check a coolant pressure passing through the electric water pump;
a vehicle cooling line including an electric water pump pumping a coolant of a vehicle radiator to circulate the coolant to an electric component and the sensor disposed at a rear end of the electric water pump to check the coolant pressure passing through the electric water pump; and
a controller configured to decrease a driving amount of the electric water pump of the fuel cell cooling line or the vehicle cooling line when a pressure change of the fuel cell cooling line or the vehicle cooling line is a reference value or higher.

7. The cooling pump driving system of claim 6, wherein the fuel cell cooling line and the vehicle cooling line are separated from each other, such that the coolant does not move therebetween.

8. The cooling pump driving system of claim 6, wherein the fuel cell cooling line protrudes outward from a coolant passage of a front side of the electric water pump to define a space, such that a diameter of the coolant passage of the front side of the electric water pump is larger than that of a coolant passage of a rear side of the electric water pump.

9. The cooling pump driving system of claim 6, wherein a coolant passage of a front end of the electric water pump of the fuel cell cooling line has an internal space capable of receiving the coolant therein and a buffer tank where the internal space and the coolant passage communicate with each other.
